(19) United States
(12) Patent Application Publication
(10) Pub. No.: US 2024/0179303 A1
(43) Pub. Date: May 30, 2024

(54) VIDEO ENCODING/DECODING METHOD AND APPARATUS

(71) Applicants: HYUNDAI MOTOR COMPANY, Seoul (KR); KIA CORPORATION, Seoul (KR)

(72) Inventors: Seung Wook Park, Yongin-si (KR); Jin Heo, Yongin-si (KR)

(73) Assignees: HYUNDAI MOTOR COMPANY, Seoul (KR); KIA CORPORATION, Seoul (KR)

(21) Appl. No.: 18/431,245

(22) Filed: Feb. 2, 2024

Related U.S. Application Data
(63) Continuation of application No. PCT/KR2022/011655, filed on Aug. 5, 2022.

(30) Foreign Application Priority Data
Aug. 5, 2021 (KR) 10-2021-0103366
Aug. 2, 2022 (KR) 10-2022-0095867

(51) Int. Cl. H04N 19/109; H04N 19/105; H04N 19/176; H04N 19/182; H04N 19/61

(52) U.S. Cl. CPC H04N 19/109; H04N 19/105; H04N 19/176; H04N 19/182; H04N 19/61

(57) ABSTRACT

A method and a device for encoding/decoding a video are provided. A method for decoding a video according to the present disclosure includes deriving a most probable mode (MPM) list based on intra prediction modes of neighboring blocks adjacent to a current block. The method for decoding the video also includes generating prediction pixels by applying candidate modes in the MPM list or the intra prediction modes of the neighboring blocks to reference pixels of a first region adjacent to the current block. The method for decoding the video also includes calculating a sum of absolute transformed difference (SATD) between the prediction pixels and reconstructed pixels of the first region. The method for decoding the video also includes deriving a first intra prediction mode, based on the SATD. The method for decoding the video also includes deriving an intra prediction mode of the current block, based on the first intra prediction mode. The method for decoding the video also includes generating a prediction block of the current block, based on the intra prediction mode of the current block.

### CROSS-REFERENCE TO RELATED APPLICATIONS

This application is a Continuation of International Application No. PCT/KR2022/011655, filed on Aug. 5, 2022, which claims priority to and the benefit of Korean Patent Application No. 10-2021-0103366, filed on Aug. 5, 2021, and Korean Patent Application No. 10-2022-0095867, filed on Aug. 2, 2022, the entire disclosures of each of which are incorporated herein by reference.

### TECHNICAL FIELD

The present disclosure relates to a video encoding/decoding method and a video encoding/decoding apparatus, and more specifically, to a video encoding/decoding method and a video encoding/decoding apparatus of deriving an optimal intra prediction mode for a current block based on a template adjacent to the current block.

### BACKGROUND

The contents described below simply provide background information related to the present embodiment and do not constitute prior art.

Since the volume of video data is larger than the volume of voice data or still image data, storing or transmitting video data without processing the video data by compression requires a lot of hardware resources including memory.

Accordingly, in storing or transmitting video data, the video data is generally compressed using an encoder so as to be stored or transmitted. Then, a decoder receives the compressed video data and decompresses and reproduces the video data. Compression techniques for such video include H.264/AVC, high efficiency video coding (HEVC), and versatile video coding (VVC), which improves coding efficiency by about 30% or more compared to HEVC.

However, the video size, resolution, and frame rate are gradually increasing, and thus the amount of data to be encoded is also increasing. Accordingly, a new compression technique having better encoding efficiency and higher image quality than the existing compression technique is required.

Intra prediction is a prediction technology that allows only spatial reference and refers to a method of predicting a current block by referring to blocks that have already been reconstructed around a block on which encoding is to be currently performed. In the case of intra-prediction, the intra-prediction mode of the current block may be derived using a most probable mode (MPM) list. In addition, the intra prediction mode of the current block may be derived using a template adjacent to the current block. In the case of deriving the intra prediction mode for the current block using a template adjacent to the current block, there is a need to improve coding efficiency.

### SUMMARY

An object of the present disclosure is to provide a method and an apparatus for deriving an intra prediction mode of a current block based on a template.

Another object of the present disclosure is to provide a method and an apparatus for deriving an intra prediction mode of a current block using only a limited template.

Another object of the present disclosure is to provide a method and an apparatus for deriving an intra prediction mode of a current block using a most probable mode (MPM) list and a template.

Another object of the present disclosure is to provide a method and an apparatus for deriving an intra prediction mode of a current block using an intra prediction mode of a reference block adjacent to the current block and a template.

Another object of the present disclosure is to provide a method and an apparatus for improving video encoding/decoding efficiency.

Another object of the present disclosure is to provide a recording medium that stores a bitstream generated by a video encoding/decoding method or a video encoding/decoding apparatus of the present disclosure.

Another object of the present disclosure is to provide a method and an apparatus for transmitting a bitstream generated by a video encoding/decoding method or an apparatus of the present disclosure.

According to a present disclosure, a video decoding method includes deriving a most probable mode (MPM) list based on intra prediction modes of neighboring blocks adjacent to a current block. The video decoding method also includes generating prediction pixels by applying candidate modes in the MPM list or the intra prediction modes of the neighboring blocks to reference pixels of a first region adjacent to the current block. The video decoding method also includes calculating a sum of absolute transformed difference (SATD) between the prediction pixels and reconstructed pixels of the first region, deriving a first intra prediction mode, based on the SATD. The video decoding method also includes deriving an intra prediction mode of the current block, based on the first intra prediction mode. The video decoding method also includes generating a prediction block of the current block, based on the intra prediction mode of the current block.

According to the present disclosure, a video encoding method includes determining a most probable mode (MPM) list, based on intra prediction modes of neighboring blocks adjacent to a current block. The video encoding method also includes generating prediction pixels by applying candidate modes in the MPM list or the intra prediction modes of the neighboring blocks to reference pixels of a first region adjacent to the current block. The video encoding method also includes calculating a sum of absolute transformed difference (SATD) between the prediction pixels and reconstructed pixels of the first region. The video encoding method also includes determining a first intra prediction mode, based on the SATD. The video encoding method also includes determining an intra prediction mode of the current block, based on the first intra prediction mode. The video encoding method also includes generating a prediction block of the current block, based on the intra prediction mode of the current block.

In addition, according to the present disclosure, it is possible to provide a method of transmitting a bitstream generated by the video encoding method or the apparatus according to the present disclosure.

In addition, according to the present disclosure, it is possible to provide a recording medium storing a bitstream generated by the video encoding method or the apparatus according to the present disclosure.

In addition, according to the present disclosure, it is possible to provide a recording medium storing a bitstream received and decoded by the video decoding apparatus according to the present disclosure and used to reconstruct a video.

According to the present disclosure, the method and an apparatus for deriving an intra prediction mode of a current block based on a template may be provided.

In addition, according to the present disclosure, the method and an apparatus for deriving an intra prediction mode of a current block using only a limited template may be provided.

In addition, according to the present disclosure, the method and an apparatus for deriving an intra prediction mode of a current block using a most probable mode (MPM) list and a template may be provided.

In addition, according to the present disclosure, a method and an apparatus for deriving an intra prediction mode of a current block using an intra prediction mode of a reference block adjacent to the current block and a template may be provided.

In addition, according to the present disclosure, the method and an apparatus for improving video encoding/decoding efficiency may be provided.

The effects that may be obtained from the present disclosure are not limited to the effects mentioned above, and other effects not mentioned may be clearly understood by those having ordinary skill in the art from the description below.

### BRIEF DESCRIPTION OF DRAWINGS

FIG. 1 is a block diagram of a video encoding apparatus that may implement a technology of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement technologies of the present disclosure.

FIG. 6 is a diagram illustrating a template used to derive a template-based intra prediction mode and a reference pixel of the template, according to an embodiment of the present disclosure.

FIG. 7 is a diagram illustrating a template used to derive a template-based intra prediction mode and a reference pixel of the template, according to another embodiment of the present disclosure.

FIG. 8 is a diagram illustrating a reference block used to generate a most probable mode (MPM) list, according to an embodiment of the present disclosure.

FIG. 9 is a diagram illustrating a method for generating an MPM list when all intra prediction modes of reference blocks are non-directional modes, according to an embodiment of the present disclosure.

FIG. 10 is a diagram illustrating a method for generating an MPM list when intra prediction modes of reference blocks are a non-directional mode and a directional mode, respectively, according to an embodiment of the present disclosure.

FIG. 11 is a diagram illustrating a method for generating an MPM list when intra prediction modes of reference blocks are different directional modes, according to an embodiment of the present disclosure.

FIG. 12 is a diagram illustrating neighboring blocks adjacent to a current block, according to an embodiment of the present disclosure.

FIG. 13 is a diagram illustrating a histogram of a mode of a block adjacent to a current block, according to an embodiment of the present disclosure.

FIG. 14 is a diagram illustrating a process of deriving a template-based intra prediction mode using a histogram of a mode of a block adjacent to a current block, according to an embodiment of the present disclosure.

FIG. 15 is a diagram illustrating 49 mode and 51 mode at resolution 64 for a vertical mode, according to an embodiment of the present disclosure.

FIG. 16 is a diagram illustrating a syntax related to a template-based intra prediction mode derivation method of FIG. 15, according to an embodiment of the present disclosure.

FIG. 17 is a diagram illustrating a method for determining a mode based on an index of FIG. 16, according to an embodiment of the present disclosure.

FIG. 18 is a diagram illustrating a video decoding process, according to an embodiment of the present disclosure.

FIG. 19 is a diagram illustrating a video encoding process, according to an embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure have been omitted for the purpose of clarity and for brevity.

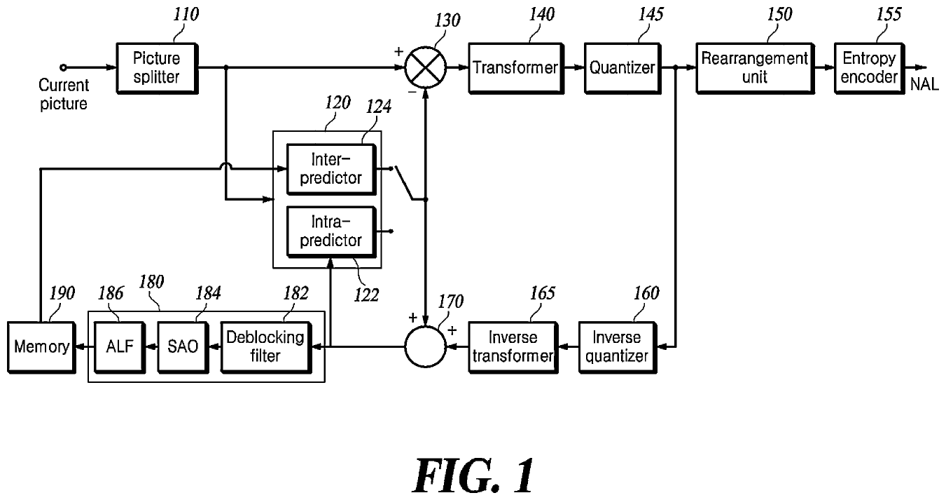

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a BTTT is added to the tree structures to be referred to as a multiple-type tree (MTT).

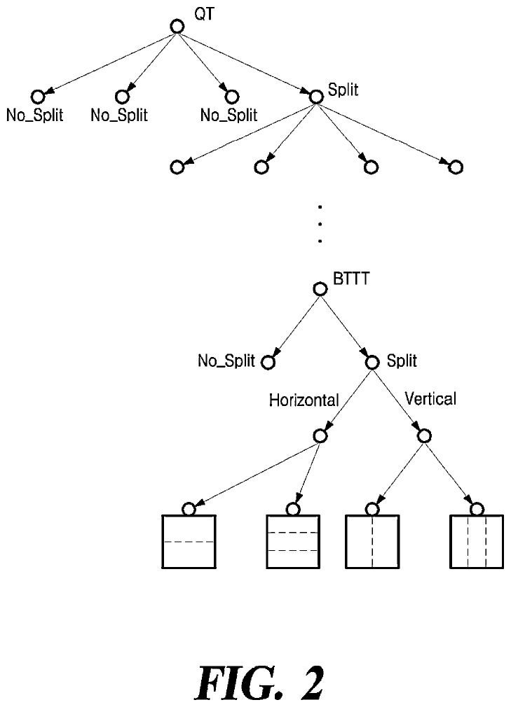

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks of a form of being asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block”. As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

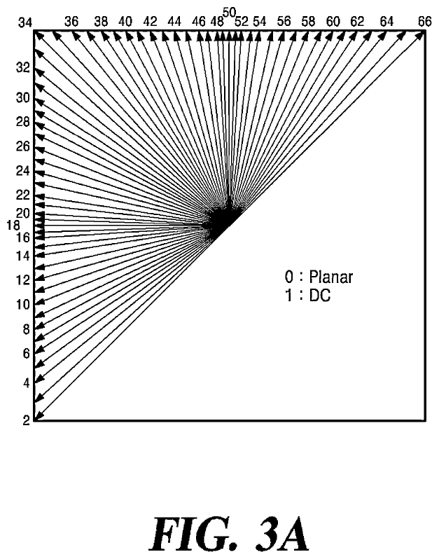

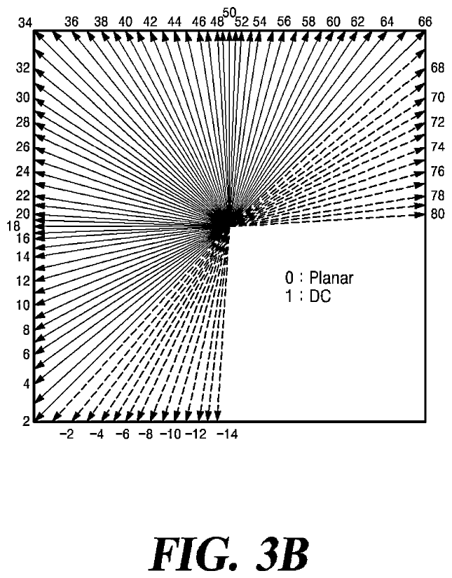

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, etc. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

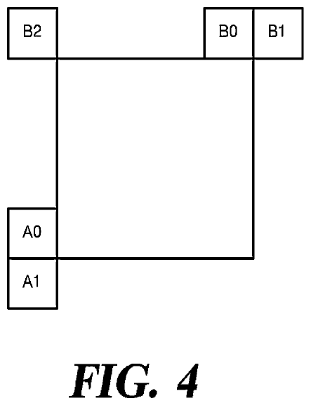

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be obtained by applying a pre-defined function (e.g., center value and average value computation, etc.) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) indicating the corresponding splitting is additionally encoded by the entropy encoder 155 and signaled to the video decoding apparatus. Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

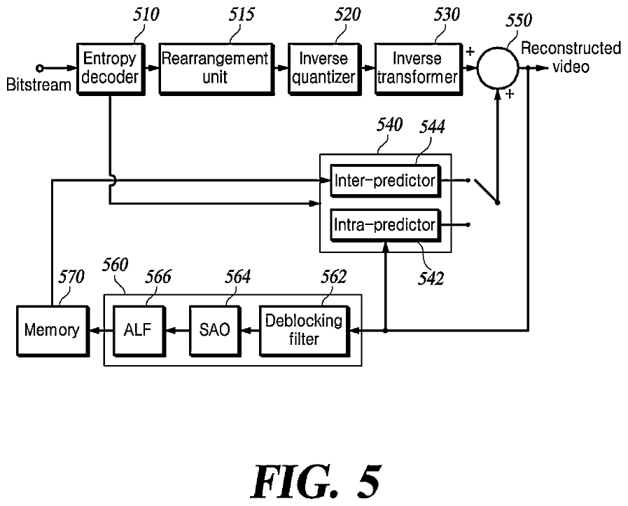

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for restoring the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by restoring the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

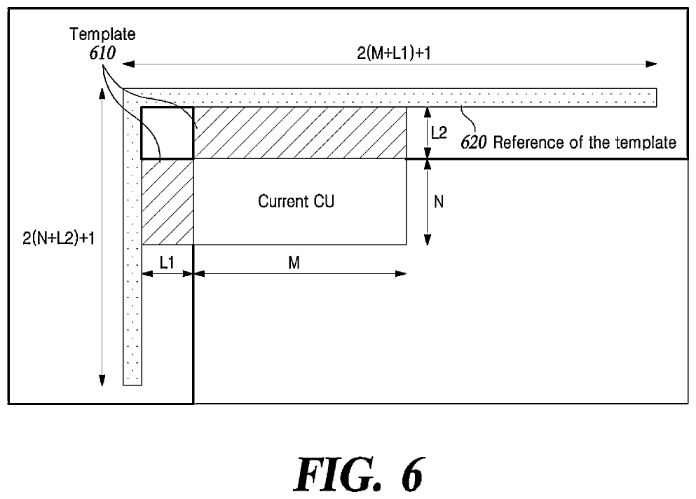

FIG. 6 is a diagram illustrating a template used to derive a template-based intra prediction mode and a reference pixel of the template, according to an embodiment of the present disclosure. An intra prediction mode of a current block may be derived using a template adjacent to the current block. A prediction template may be generated by applying directionality of all candidate modes in the MPM list to reference pixels of the template. The sum of absolute transformed difference (SATD) of pixels of a generated prediction template and pixels of an already reconstructed template may be calculated. Among the MPM candidate modes, a mode having the smallest SATD is the intra prediction mode of the current block derived by the template-based intra prediction mode derivation method. The intra prediction mode of the current block derived by the template-based intra prediction mode derivation method may be used as an additional mode for a current coding unit (CU) block.

In a sequence parameter set, a flag indicating whether to use the template-based intra prediction derivation method may be signaled. In the case of using the template-based intra prediction derivation method, whether to apply the template-based intra prediction derivation method may be expressed at the coding unit level using a coding unit level flag. When the current coding unit block uses the template-based intra prediction derivation method, the decoding apparatus may derive information on the intra prediction mode of the current coding unit block using the template-based intra prediction derivation method. Accordingly, signaling of a syntax related to the intra prediction mode for the remaining luminance components may be omitted.

Referring to FIG. 6, a template 610 used in the template-based intra prediction derivation method may be adjacent to the top and left of the current block. A reference pixel 620 of the template to which directionality of all candidate modes in the MPM list is applied may exist adjacent to the template 610. A prediction template may be generated by applying the directionality of all candidate modes in the MPM list to the reference pixel 620 of the template.

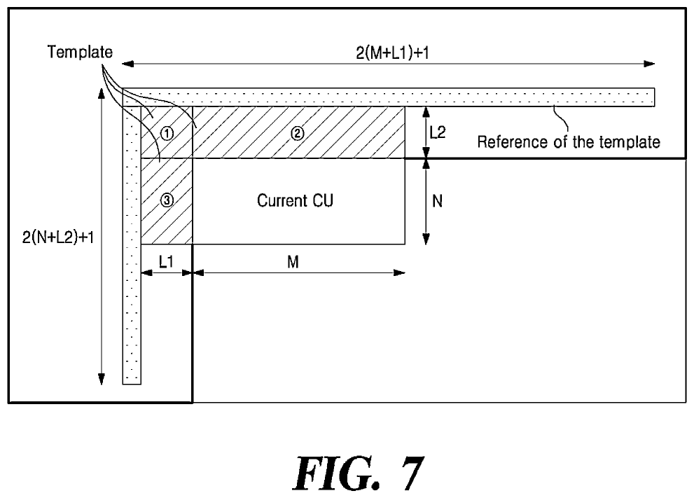

FIG. 7 is a diagram illustrating a template used to derive a template-based intra prediction mode and a reference pixel of the template, according to another embodiment of the present disclosure. The template used in the template-based intra prediction mode derivation method may be selected randomly. Calculating the SATD between prediction template pixels generated by applying the directionality of all candidate modes in the MPM list to the reference pixels of the template and the reconstructed template pixels has high complexity. The template used to derive the template-based intra prediction mode may be variably selected depending on the directionality of the candidate mode in the MPM list. The SATD between the pixels of the selected template and the prediction template pixels may be calculated. In addition to the SATD, various error measurement methods, such as the sum of absolute difference or the sum of square error may be used.

Referring to FIG. 7, as an example, the template used in the template-based intra prediction mode derivation method may correspond to template \textcircled{1}, template \textcircled{2}, and template \textcircled{3}. Template \textcircled{1} may be adjacent to the top left of the current block. Template \textcircled{2} may be adjacent to the top of the current block. Template \textcircled{3} may be adjacent to the left of the current block. The reference pixel of the template may exist adjacent to template \textcircled{1}, template \textcircled{2}, and template \textcircled{3}. The shape and size of the template may be randomly determined. For example, if a candidate mode selected from the MPM list is the vertical mode, only template \textcircled{2} may be used. If the candidate mode selected from the MPM list is the horizontal mode, only template \textcircled{3} may be used. If the candidate mode selected from the MPM list is the planar mode or the DC mode, which are non-directional modes, both template \textcircled{2} and template \textcircled{3} may be used.

For example, if a candidate mode selected from the MPM list is the vertical mode, only template \textcircled{3} may be used. If the candidate mode selected from the MPM list is the horizontal mode, only template \textcircled{2} may be used.

For example, if a candidate mode selected from the MPM list is the vertical mode, some pixels of template \textcircled{2} and template \textcircled{3} may be used. Here, some pixels of the template \textcircled{3} may be randomly determined considering the size of the current block or a randomly determined subsample ratio. If a candidate mode selected from the MPM list is the horizontal mode, some pixels of template \textcircled{3} and template \textcircled{2} may be used. Here, some pixels of template \textcircled{2} may be randomly determined considering the size of the current block or a randomly determined subsample ratio.

For example, if a candidate mode selected from the MPM list is the vertical mode, some pixels of template \textcircled{3} and template \textcircled{2} may be used. Here, some pixels of the template \textcircled{2} may be randomly determined considering the size of the current block or a randomly determined subsample ratio. If a candidate mode selected from the MPM list is the horizontal mode, some pixels of template \textcircled{2} and template \textcircled{3} may be used. Here, some pixels of the template \textcircled{3} may be randomly determined considering the size of the current block or a randomly determined subsample ratio.

For example, if a candidate mode selected from the MPM list is the vertical mode, template \textcircled{1} and template \textcircled{2} may be used. If a candidate mode selected from the MPM list is the horizontal mode, template \textcircled{1} and template \textcircled{3} may be used. If a candidate mode selected from the MPM list is the planar mode or the DC mode, which is a non-directional mode, template \textcircled{1}, template \textcircled{2}, and template \textcircled{3} may be used.

For example, if a candidate mode selected from the MPM list is the vertical mode, template \textcircled{1} and template \textcircled{3} may be used. If a candidate mode selected from the MPM list is the horizontal mode, template \textcircled{1} and template \textcircled{2} may be used.

For example, if a candidate mode selected from the MPM list is the vertical mode, some pixels of template \textcircled{1}, template \textcircled{2}, and template \textcircled{3} may be used. If a candidate mode selected from the MPM list is the horizontal mode, some pixels of template \textcircled{1}, template \textcircled{3}, and template \textcircled{2} may be used. Here, some pixels of the template may be randomly determined considering the size of the current block or a randomly determined subsample ratio.

For example, if a candidate mode selected from the MPM list is the vertical mode, some pixels of template \textcircled{1}, template \textcircled{3}, and template \textcircled{2} may be used. If a candidate mode selected from the MPM list is the horizontal mode, some pixels of template \textcircled{1}, template \textcircled{2}, and template \textcircled{3} may be used. Here, some pixels of the template may be randomly determined considering the size of the current block or a randomly determined subsample ratio.

In the above embodiments, the ranges of the vertical mode and the horizontal mode may be determined to be certain ranges. If the template used in the template-based intra prediction mode derivation method is selected variably according to the direction of the candidate mode in the MPM list, complexity may be reduced.

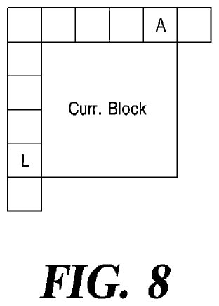

FIG. 8 is a diagram illustrating a reference block used to generate an MPM list, according to an embodiment of the present disclosure. Whether to use the template-based intra prediction mode derivation method may be determined based on the intra prediction mode of a reference block adjacent to the current block.

Referring to FIG. 8, reference block A adjacent to the top of the current block and reference block L adjacent to the left of the current block may be used to generate the MPM list. The intra prediction mode of the reference block A may mean A mode. The intra prediction mode of the reference block L may mean L mode. Whether to use the template-based intra prediction mode derivation method may be determined using A mode and L mode.

Referring to Method 1, when the A mode and the L mode are the same, there is a high probability that neighboring blocks of the current block have one directional mode or one non-directional mode. In this case, the intra prediction mode of the current block may have a high probability of having the same or similar directional mode as the reference block A and the reference block L. The intra prediction mode of the current block may be effectively encoded using the MPM list generated by A mode and L mode. Therefore, if the A mode and the L mode are the same, the template-based intra prediction mode derivation method may not be used.

Referring to Method 2, a case in which both A mode and L mode are non-directional modes includes a total of three cases in which both A mode and L mode are planar modes, in which both A mode and L mode are DC modes, and in which A mode and L mode are the planar mode and the DC mode, respectively. If the intra prediction modes of reference blocks adjacent to the current block are all non-directional modes, there may be no directional information around the current block. If the intra prediction modes of neighboring reference blocks around the current block are all non-directional modes, the MPM list may be configured using a specific default mode. When the MPM list is configured using the default mode, deriving the intra prediction mode based on the template may result in low encoding efficiency. Accordingly, when both A mode and L mode are non-directional modes, the template-based intra prediction mode derivation method may not be used.

In Method 1, only when the A mode and L mode are the same as non-directional modes, the template-based intra prediction mode derivation method may not be used. In addition, only when the A mode and L mode are the same as directional mode, the template-based intra prediction mode derivation method may not be used. In addition, if A mode and L mode are the same without distinction between the directional mode and the non-directional mode, the template-based intra prediction mode derivation method may not be used. Method 1 and Method 2 may be used independently or in combination. By applying only method 1, whether to use the template-based intra prediction mode derivation method may be determined. By applying only method 2, whether to use the template-based intra prediction mode derivation method may be determined. By combining Method 1 and Method 2, whether to use the template-based intra prediction mode derivation method may be determined.

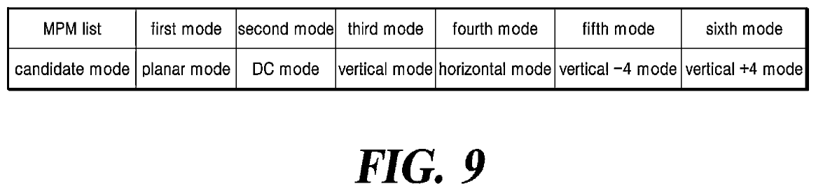

FIG. 9 is a diagram illustrating a method for generating an MPM list when all intra prediction modes of reference blocks are non-directional modes, according to an embodiment of the present disclosure. Candidate modes in the MPM list may be generated based on the intra prediction mode of a reference block adjacent to the top of the current block and the intra prediction mode of a reference block adjacent to the left of the current block. If both the intra prediction mode of the reference block adjacent to the top of the current block and the intra prediction mode of the reference block adjacent to the left of the current block are not non-directional modes, the MPM list may be generated based on the intra prediction mode of the reference block with direction information. In this case, the candidate mode in the MPM list may be determined to be a mode similar to the intra prediction mode of the reference block. Considering the characteristics of the MPM list, the intra prediction mode of the reference block, which is a directional mode, may be applied to a reference pixel of a template to generate a prediction template pixel. The SATD between the prediction template pixel and a reconstructed template pixel may be calculated. Whether to apply the template-based intra prediction mode derivation method to each candidate mode in the MPM list may be determined based on the calculated SATD.

Referring to FIG. 9, when the intra prediction modes of reference blocks adjacent to the current block are all non-directional modes, an MPM list may be generated using predefined default modes. The predefined default modes may include the vertical mode, the horizontal mode, a vertical −4 mode, and a horizontal +4 mode. The vertical −4 mode may represent −4 mode based on the vertical mode. The horizontal +4 mode may represent +4 mode based on the horizontal mode. The MPM list may include the planar mode, the DC mode, the vertical mode, the horizontal mode, the vertical −4 mode, and the horizontal +4 mode. The directionality of all candidate modes in the MPM list may be applied to each reference pixel of the template to generate a prediction template pixel. It may be calculated as the SATD between the prediction template pixel and the reconstructed template pixel. A candidate mode having the smallest value among the calculated SATD may be determined as the intra prediction mode of the current block.

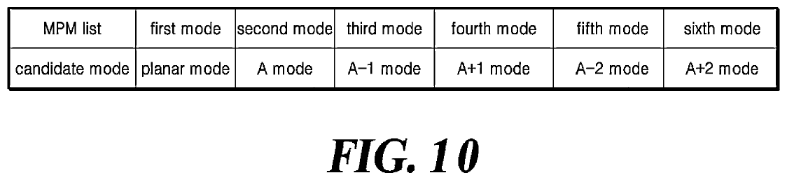

FIG. 10 is a diagram illustrating a method for generating an MPM list when the intra prediction modes of a reference block is a non-directional mode and a directional mode, respectively, according to an embodiment of the present disclosure. In FIG. 8, the reference block A adjacent to the top of the current block and the reference block L adjacent to the left of the current block may be used to generate the MPM list. The intra prediction mode of the reference block A may mean A mode. The intra prediction mode of the reference block L may mean L mode. Calculating the template-based SATD for the candidate mode may mean generating a prediction template pixel by applying directionality of the candidate mode to the reference pixel of the template and calculating the SATD between the generated prediction template pixel and the reconstructed template pixel.

Referring to FIG. 10, when A mode and L mode are a directional mode and a non-directional mode, respectively, or when A mode and L mode are the same directional mode, the MPM list may be generated based on A mode, which is the directional mode. The MPM list may include the planar mode, the A mode, A−1 mode, A+1 mode, A−2 mode, and A+2 mode. A−1 mode, A+1 mode, A−2 mode, and A+2 mode may represent −1 mode, +1 mode, −2 mode, and +2 mode, respectively, based on A mode. The template-based SATD for A mode may be calculated. Based on the calculated value, whether to calculate the template-based SATD for the remaining candidate modes in the MPM list may be determined. SATD_{X} may mean the template-based SATD for any X mode. Threshold and Threshold_1 may each mean a randomly set threshold value (Threshold>0, Threshold_1>0). As an example, SATD_{Planar} may represent the template-based SATD for the Planar mode. SATD₅₀ may represent the template-based SATD for 50 mode.

Referring to Method 1, the template-based SATDs for the planar mode and A mode may be calculated. The template-based SATD for the planar mode and the template-based SATD for the A mode may be compared. If SATD_{A}<Threshold*SATD_{Planar}, the template-based SATD for A−1 mode, A+1 mode, A−2 mode, and A+2 mode may be calculated. A mode having the smallest value among the calculated template-based SATDs may be determined as the intra prediction mode of the current coding unit block.

Referring to Method 2, the template-based SATDs for the planar mode, A mode, A−1 mode, and A+1 mode may be calculated. The template-based SATD for the A−1 mode and the template-based SATD for the A+1 mode may be compared. If SATD_{A-1}<Threshold*SATD_{A+1}, the template-based SATD for A−2 mode may be calculated. If SATD_{A-1}>Threshold*SATD_{A+1}, the template-based SATD for A+2 mode may be calculated. If SATD_{A-1}=Threshold*SATD_{A+1}, the template-based SATD for A−2 mode and A+2 mode may be calculated. The mode having the smallest value among the calculated template-based SATDs may be determined as the intra prediction mode of the current coding unit block.

Referring to Method 3, the template-based SATDs for the planar mode, A mode, A−1 mode, and A+1 mode may be calculated. The template-based SATD for the A mode and the template-based SATD for the A−1 mode may be compared. The template-based SATD for the A mode and the template-based SATD for the A+1 mode may be compared. If SATD_{A-1}<Threshold*SATD_{A}, the template-based SATD for A−2 mode may be calculated. If SATD_{A+1}<Threshold*SATD_{A}, the template-based SATD for A+2 mode may be calculated. The mode having the smallest value among the calculated template-based SATDs may be determined as the intra prediction mode of the current coding unit block.

Referring to Method 4, Method 4 may correspond to a method that combines Method 1 and Method 2. The template-based SATDs for the planar mode and A mode may be calculated. The template-based SATD for the planar mode and the template-based SATD for the A mode may be compared. If SATD_{A}<Threshold*SATD_{Planar}, the template-based SATDs for A−1 mode and A+1 mode may be calculated. If SATD_{A}<Threshold*SATD_{Planar}, the template-based SATD for the A−1 mode and the template-based SATD for the A+1 mode may be compared. If SATD_{A-1}<Threshold_1*SATD_{A+1}, the template-based SATD for A−2 mode may be calculated. If SATD_{A-1}>Threshold_1*SATD_{A+1}, the template-based SATD for A+2 mode may be calculated. If SATD_{A-1}=Threshold_1*SATD_{A+1}, the template-based SATDs for A−2 mode and A+2 mode may be calculated. The mode having the smallest value among the calculated template-based SATDs may be determined as the intra prediction mode of the current coding unit block.

Referring to Method 5, Method 5 may correspond to a method that combines Method 1 and Method 3. The template-based SATDs for the planar mode and A mode may be calculated. The template-based SATD for the planar mode and the template-based SATD for the A mode may be compared. If SATD_{A}<Threshold*SATD_{Planar}, the template-based SATD for A−1 mode and A+1 mode may be calculated. If SATD_{A}<Threshold*SATD_{Planar}, the template-based SATD for the A mode and the template-based SATD for the A−1 mode may be compared. Then, the template-based SATD for the A mode and the template-based SATD for the A+1 mode may be compared. If SATD_{A-1}<Threshold_1*SATD_{A}, the template-based SATD for A−2 mode may be calculated. If SATD_{A+1}<Threshold_1*SATD_{A}, the template-based SATD for A+2 mode may be calculated. The mode having the smallest value among the calculated template-based SATDs may be determined as the intra prediction mode of the current coding unit block.

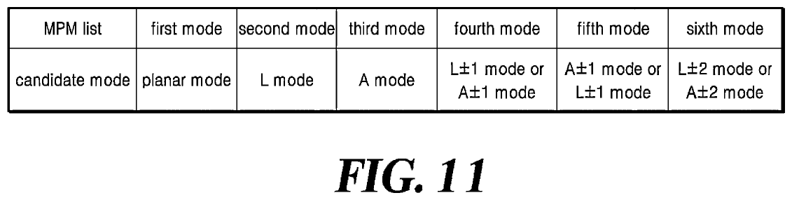

FIG. 11 is a diagram illustrating a method for generating an MPM list when intra prediction modes of reference blocks are different directional modes, according to an embodiment of the present disclosure. In FIG. 8, the reference block A adjacent to the top of the current block and the reference block L adjacent to the left of the current block may be used to generate an MPM list. The intra prediction mode of the reference block A may mean A mode. The intra prediction mode of the reference block L may mean L mode.

Referring to FIG. 11, when A mode and L mode are different directional modes, an

MPM list may be generated using each directional mode. In the MPM list, a first mode is the planar mode, a second mode is the L mode, a third mode is the A mode, a fourth mode is L+1 mode or A+1 mode, a fifth mode is A+1 mode or L+1 mode, and a sixth mode is L+2 mode or A+2 mode. The fourth, fifth, and sixth modes may be derived from A mode and L mode. In this case, the template-based SATDs for the second mode, L mode, and the third mode, A mode, may be calculated. Based on the calculated template-based SATD, whether to calculate the template-based SATD for a specific candidate mode in the MPM list may be determined.

Referring to Method 1, the template-based SATDs for the planar mode, L mode, and A mode may be calculated. The template-based SATD for the planar mode and the template-based SATD for the L mode may be compared. Then, the template-based SATD for the planar mode and the template-based SATD for the A mode may be compared. If SATD_{L}<Threshold*SATD_{Planar}, the sum of template-based SATD for the mode derived from the L mode may be calculated. If SATD_{A}<Threshold*SATD_{Planar}, the template-based SATD for the mode derived from the A mode may be calculated. The mode having the smallest value among the calculated template-based SATDs may be determined as the intra prediction mode of the current coding unit block.

Referring to Method 2, the template-based SATDs for the planar mode, L mode, and A mode may be calculated. The template-based SATD for A mode and the template-based SATD for L mode may be compared. If SATD_{L}<Threshold*SATD_{A}, the template-based SATD for the mode derived from the L mode may be calculated. If SATD_{L}>Threshold*SATD_{A}, the template-based SATD for the mode derived from A mode may be calculated. If SATD_{L}=Threshold*SATD_{A}, the template-based SATD for all remaining modes in the MPM list may be calculated. The mode having the smallest value among the calculated template-based SATDs may be determined as the intra prediction mode of the current coding unit block.

Referring to Method 3, the template-based SATDs for the planar mode and L mode may be calculated. The template-based SATD for the planar mode and the template-based SATD for the L mode may be compared. If SATD_{L}<Threshold*SATD_{Planar}, the template-based SATD for A mode may be calculated. If not SATD_{L}<Threshold*SATD_{Planar}, the template-based SATD for the remaining candidate modes in the MPM list may not be calculated. If SATD_{A}<Threshold*SATD_{Planar}, the template-based SATD for all remaining candidate modes may be calculated. If not SATD_{A}<Threshold*SATD_{Planar}, the template-based SATD for the remaining candidate modes in the MPM list may not be calculated. The mode having the smallest value among the calculated template-based SATDs may be determined as the intra prediction mode of the current coding unit block.

The template-based SATDs for A mode and L mode, which are the reference for generating the MPM list, may be compared in various manners. Instead of calculating the template-based SATD for all candidate modes in the MPM list based on the comparison result, the template-based SATD for a specific candidate mode may be calculated. Through this, complexity may be reduced.

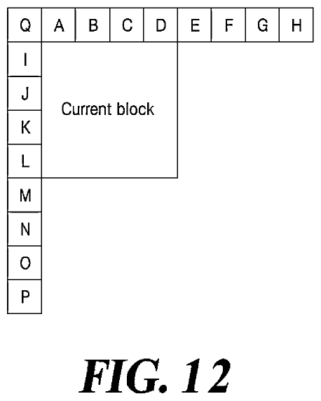

FIG. 12 is a diagram illustrating neighboring blocks adjacent to the current block, according to an embodiment of the present disclosure. Calculating the template-based SATD for the intra prediction mode of the reference block may mean generating a prediction template by applying the directionality of the intra prediction mode of the reference block to the reference pixels of the template and calculating the SATD between pixels of the generated prediction template and the reconstructed template.

Referring to FIG. 12, neighboring top blocks A to H, left blocks I to P, and top left blocks Q may exist around the current block. The template-based SATD for the intra prediction mode of top blocks A to H, left blocks I to P, and top left block Q may be calculated. Here, the number and location of the top block, left block, and top left block used may be randomly determined. The mode having the smallest value among the calculated template-based SATDs may be determined as the intra prediction mode of the current block. Coding efficiency may be improved by using various intra prediction modes of reference blocks adjacent to the current block. The template-based SATDs may be calculated only for different intra prediction modes of reference blocks adjacent to the current block. In other words, the template-based SATD may be calculated only for a new intra prediction mode through redundancy checking.

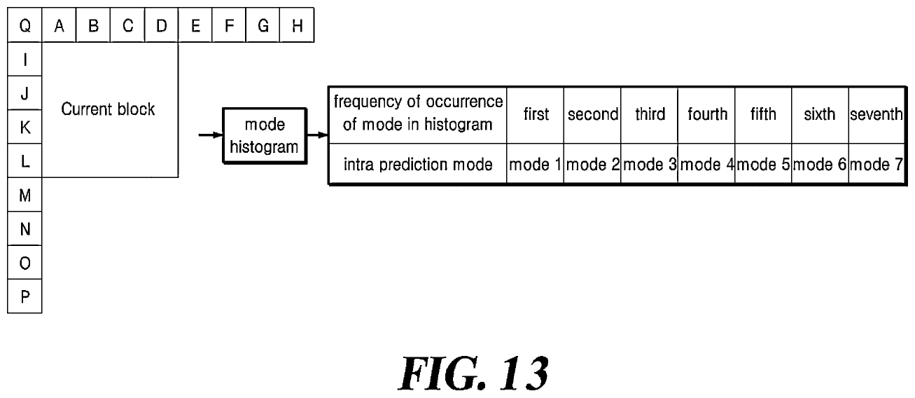

FIG. 13 is a diagram illustrating a histogram of a mode of a block adjacent to a current block, according to an embodiment of the present disclosure.

Referring to FIG. 13, a mode histogram of blocks adjacent to the current block may be configured. In the generated mode histogram, modes may be sorted in descending order of frequency of occurrence of modes. Mode 1, Mode 2, Mode 3, Mode 4, Mode 5, Mode 6, and Mode 7 may represent any intra prediction mode. Mode 1, mode 2, mode 3, mode 4, mode 5, mode 6, and mode 7 may refer to intra prediction modes of blocks adjacent to the current block. If there are intra prediction modes with the same frequency of occurrence, the intra prediction modes may be sorted starting from the lowest number. Alternatively, the intra prediction modes may be sorted starting from the highest number.

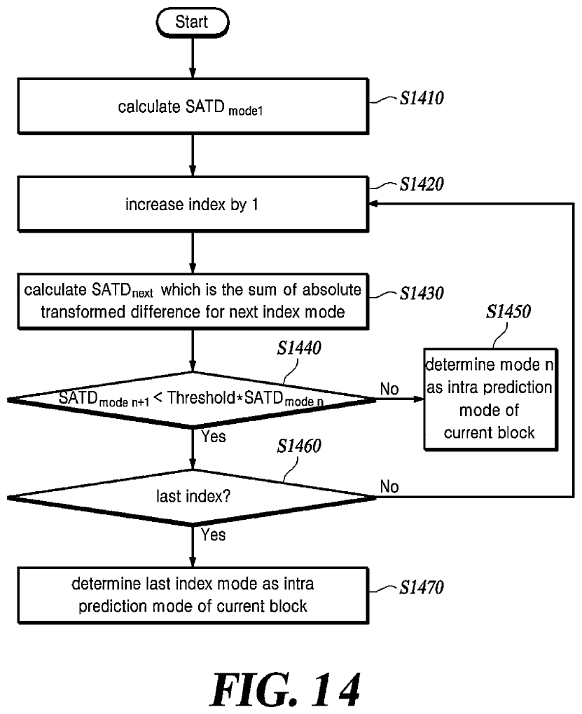

FIG. 14 is a diagram illustrating a process of deriving a template-based intra prediction mode using a histogram of a mode of a block adjacent to a current block, according to an embodiment of the present disclosure.

Referring to FIG. 14, SATD_{mode 1}, the template-based SATD for mode 1, which is a first index mode, may be calculated from the histogram of the mode generated in FIG. 13 (S1410). Index 1 may be increased (S1420). SATDₙₑₓₜ, which is the SATD for the next index mode, may be calculated (S1430). Whether SATD_{mode n+1}<Threshold*SATD_{mode n} may be determined (S1440). Here, SATD_{mode n+1} may correspond to the SATD for mode 2 and SATD mode n may correspond to the SATD for mode 1. SATD_{mode n+1} may correspond to SATDₙₑₓₜ, which is the SATD for a next index mode. If not SATD_{mode n+1}<Threshold*SATD_{mode n} (S1440—NO), mode n may be determined as the intra prediction mode of the current block (S1450). If SATD_{mode n+1}<Threshold*SATD_{mode n} (S1440—YES), whether mode n+1 corresponds to the last index mode (S1460). If mode n+1 is the last index mode (S1460—YES), the last index mode may be determined as the intra prediction mode of the current block (S1470). The last index mode may correspond to mode 7. If mode n+1 is not the last index mode (S1460—NO), index 1 may be increased. The SATD for the increased index mode may be calculated.

In this manner, the process of comparing the template-based SATD may be terminated when the template-based SATD for the mode having a small index number is less than the template-based SATD for the mode having a large index number. At this time, the mode having a small index number may be determined as the intra prediction mode for the current block. Alternatively, when the currently compared index number is the last index in the mode histogram, the process of comparing the template-based SATD may be terminated. Through this process, complexity may be reduced.

Mode Allocation Method when Intra Prediction Mode of Reference Block is Derived by Template-Based Intra Prediction Mode Derivation Method

In the case of deriving the intra prediction mode of the current block based on a template, the intra prediction mode of a reference block adjacent to the current block may be used. Here, if the intra prediction mode of the reference block is derived by the template-based intra prediction mode derivation method, the intra prediction mode of the reference block may be replaced with a specific mode. Here, the specific mode may correspond to the planar mode, the DC mode, or a specific directional mode.

Mode Allocation Method when Intra Prediction Mode of Luma Block is Derived by Template-Based Intra Prediction Mode Derivation Method

When the intra prediction mode of a chroma block is a direct mode (DM) mode, the intra prediction mode of the chroma block may be derived to the intra prediction mode of a corresponding luminance block. Here, if the intra prediction mode of the corresponding luminance block is derived by the template-based intra prediction mode derivation method, the intra prediction mode of the corresponding luminance block may be replaced with a specific mode. Here, the specific mode may correspond to the planar mode, the DC mode, or a specific directional mode.

### Template-Based SATD-Oriented Adaptive Search Method

The template-based intra prediction mode derivation method is a method of deriving the intra prediction mode of the current block based on the template-based SATD for the intra prediction modes of neighboring blocks of the current block or candidate modes in the MPM list, without information transmitted from the encoding apparatus. Accordingly, specific directionality existing around the current block may be well reflected. Considering these characteristics, the following two methods are proposed.

Referring to Method 1, an X mode, which is a representative directional mode, may be derived by applying the Sobel operation to the template region. The template-based SATD for the planar mode, DC mode, X mode, X−1 mode, X+1 mode and X−2 mode may be calculated. Alternatively, the template-based SATD for the planar mode, DC mode, X mode, X−1 mode, X+1 mode, and X+2 mode may be calculated. Here, the mode having the smallest SATD may be determined as the intra prediction mode of the current block. To reduce the complexity of the Sobel operation, the size of the template region may be variably adjusted. As the size of the template region is adjusted, the position of the reference template may also be variably adjusted.

Referring to Method 2, when the intra prediction mode of the current block is determined using the template-based intra prediction mode derivation method, only the intra prediction mode of a block encoded in the intra prediction mode derived by the template-based intra prediction mode derivation method among the intra prediction modes in the MPM list or the intra prediction modes of neighboring blocks around the current block may be used.

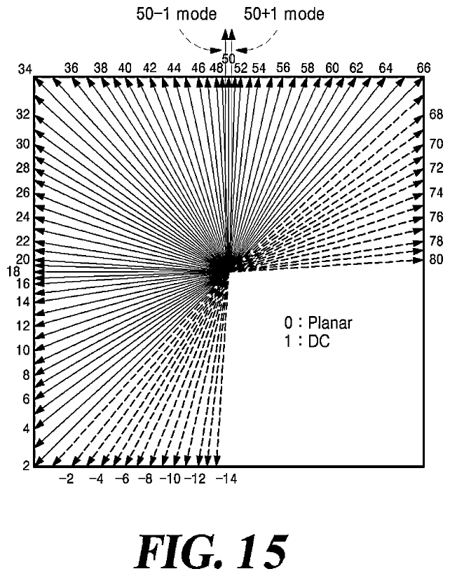

FIG. 15 is a diagram illustrating 49 mode and 51 mode at resolution 64 for vertical mode, according to an embodiment of the present disclosure. An intra prediction mode may be derived using a directional mode that does not exist in the existing intra prediction mode. The SATD for candidate modes in the MPM list or intra prediction modes of neighboring blocks around the current block may be calculated. The mode in which the calculated value has the smallest value may be determined. If the determined mode is a non-directional mode, the corresponding mode may be determined as the intra prediction mode of the current block. If the corresponding mode is a directional mode, the template-based SATDs for ±1 mode of the corresponding mode may be calculated at a resolution other than the existing resolution 32. Based on the calculated value, the mode having the smallest value may be determined as the intra prediction mode of the current block.

Referring to FIG. 15, the SATD for candidate modes in the MPM list or intra prediction modes of neighboring blocks around the current block may be calculated. The mode in which the calculated value has the smallest value may be determined. If the determined mode is mode 50, the template-based SATD for 50±1 mode at resolution 64 may be calculated. At resolution 64, the mode having a smaller value among the template-based SATD for mode 49 and the template-based SATD for mode 51 may be determined as the intra prediction mode of the current block. The size of the increase or decrease in resolution and mode may be determined randomly. Resolution 32 may mean dividing one specific section into 32 equal sections. Mode 49 and mode 51 at resolution 64 do not exist in the intra prediction mode at resolution 32. At resolution 64, mode 49 may exist between mode 49 and mode 50 at resolution 32. At resolution 64, mode 51 may exist between mode 50 and mode 51 at resolution 32. In this manner, the template-based intra prediction mode may be derived using an intra prediction mode that does not exist at resolution 32. Through this, coding efficiency may be improved.

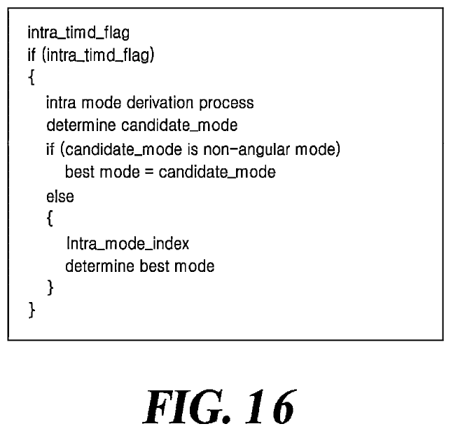

FIG. 16 is a diagram illustrating syntax related to the template-based intra prediction mode derivation method of FIG. 15, according to an embodiment of the present disclosure.

Referring to FIG. 16, information (e.g., intra_timd_flag) indicating whether the template-based intra prediction mode derivation method is used may be signaled. If intra_timd_flag is a first value (e.g., 0), the template-based intra prediction mode derivation method may not be used. If intra_timd_flag is a second value (e.g., 1), the template-based intra prediction mode derivation method may be used. If intra_timd_flag is the second value (e.g., 1) and the derived intra prediction mode is a non-directional mode, the corresponding non-directional mode may be determined as the intra prediction mode of the current block. If intra_timd_flag is the second value (e.g., 1) and the derived intra prediction mode is a directional mode, index information (e.g., intra_mode_idex) may be signaled. The intra prediction mode of the current block may be determined depending on the value of intra_mode_idex.

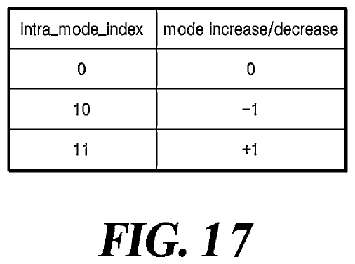

FIG. 17 is a diagram illustrating a method for determining a mode based on the index of FIG. 16, according to an embodiment of the present disclosure. Based on the values of the index information in FIG. 16, the intra prediction mode derived at a predetermined resolution may be increased, maintained, or decreased.

Referring to FIG. 17, if the predetermined resolution is 64, the intra prediction mode derived by the template-based intra prediction mode derivation method is mode 40, and intra_mode_idex is 0, then the intra prediction mode of the current block may be mode 40 at resolution 64. If the predetermined resolution is 64, the intra prediction mode derived by the template-based intra prediction mode derivation method is mode 40, and intra_mode_idex is 10, then the intra prediction mode of the current block may be mode 39 at resolution 64. If the predetermined resolution is 64, the intra prediction mode derived by the template-based intra prediction mode derivation method is mode 40, and intra_mode_idex is 11, then the intra prediction mode of the current block may be mode 41 mode at resolution 64.

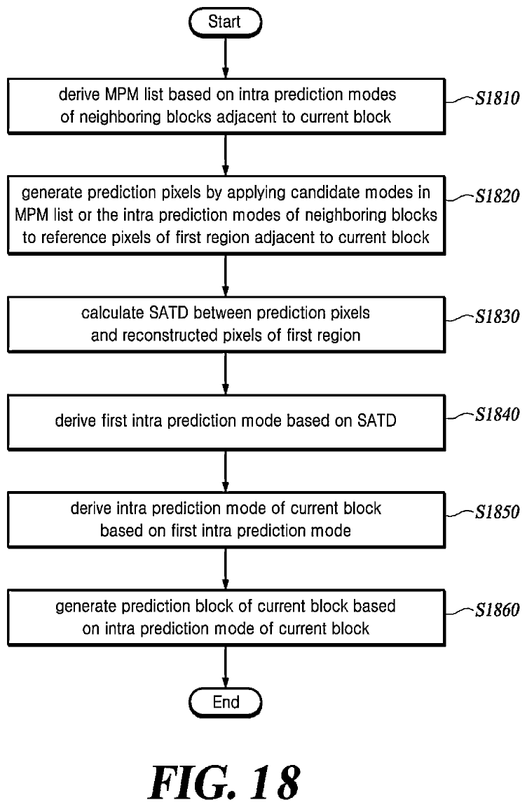

FIG. 18 is a diagram illustrating a video decoding process according to an embodiment of the present disclosure.

Referring to FIG. 18, the decoding apparatus may derive an MPM list based on the intra prediction modes of neighboring blocks adjacent to the current block (S1810). The decoding apparatus may generate prediction pixels by applying candidate modes in the MPM list or intra prediction modes of neighboring blocks to reference pixels of a first region adjacent to the current block (S1820). Prediction pixels may be generated based on the intra prediction modes of the neighboring blocks. The first region may correspond to at least one of a top region, a left region, or a top left region of the current block. The first region may be determined based on candidate modes in the MPM list. Generating prediction pixels may include generating an intra prediction mode list based on intra prediction modes of the neighboring blocks and generating prediction pixels based on the intra prediction mode list. Alternatively, generating prediction pixels may include deriving a second intra prediction mode by applying a Sobel operation to the first region and generating prediction pixels based on the second intra prediction mode.

The decoding apparatus may calculate the SATD between the prediction pixels and reconstructed pixels of the first region (S1830). The decoding apparatus may derive the first intra prediction mode based on the SATD (S1840). The first intra prediction mode may correspond to a candidate mode used to generate a prediction pixel having the minimum SATD. The first intra prediction mode may correspond to the intra prediction mode of a neighboring block used to generate the prediction pixel having the minimum SATD. The decoding apparatus may derive the intra prediction mode of the current block based on the first intra prediction mode (S1850). The operation of deriving the intra prediction mode of the current block based on the first intra prediction mode may correspond to an operation of deriving the first intra prediction mode as the intra prediction mode of the current block based on that the first intra prediction mode is a non-directional mode. The operation of deriving the intra prediction mode of the current block based on the first intra prediction mode includes an operation of deriving a third intra prediction mode and a fourth intra prediction mode by increasing and decreasing the first intra prediction mode to a predetermined size at a predetermined resolution based on that the first intra prediction mode is a directional mode. The operation of deriving the intra prediction mode of the current block based on the first intra prediction mode also includes an operation of deriving the intra prediction mode of the current block based on the third intra prediction mode and the fourth intra prediction mode. The decoding apparatus may generate a prediction block of the current block based on the intra prediction mode of the current block (S1860).

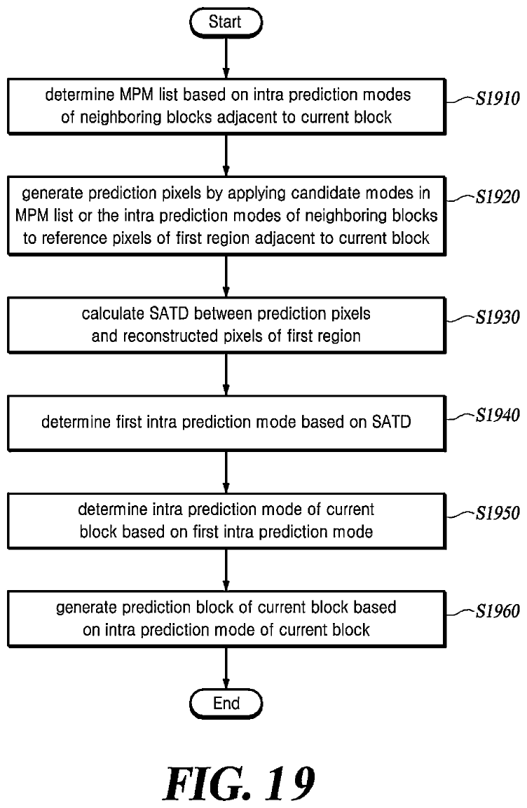

FIG. 19 is a diagram illustrating a video encoding process, according to an embodiment of the present disclosure.

Referring to FIG. 19, the encoding apparatus may determine the MPM list based on the intra prediction modes of neighboring blocks adjacent to the current block (S1910). The encoding apparatus may generate prediction pixels by applying candidate modes in the MPM list or intra prediction modes of neighboring blocks to reference pixels of the first region adjacent to the current block (S1920). Prediction pixels may be generated based on intra prediction modes of neighboring blocks. The first region may correspond to at least one of the top region, left region, or top left region of the current block. The first region may be determined based on candidate modes in the MPM list. An operation of generating prediction pixels may include generating an intra prediction mode list based on intra prediction modes of neighboring blocks and generating prediction pixels based on the intra prediction mode list. Alternatively, an operation of generating prediction pixels may include determining a second intra prediction mode by applying a Sobel operation to the first region and generating prediction pixels based on the second intra prediction mode.

The encoding apparatus may calculate the SATD between the prediction pixels and reconstructed pixels of the first region (S1930). The encoding apparatus may determine the first intra prediction mode based on the SATD (S1940). The first intra prediction mode may correspond to a candidate mode used to generate a prediction pixel having the minimum SATD. The first intra prediction mode may correspond to the intra prediction mode of the neighboring block used to generate the prediction pixel having the minimum SATD. The encoding apparatus may determine the intra prediction mode of the current block based on the first intra prediction mode (S1950). The operation of determining the intra prediction mode of the current block based on the first intra prediction mode may correspond to the operation of determining the first intra prediction mode as the intra prediction mode of the current block based on that the first intra prediction mode is a non-directional mode. The operation of determining the intra prediction mode of the current block based on the first intra prediction mode may include determining a third intra prediction mode and a fourth intra prediction mode by increasing and decreasing the first intra prediction mode to a predetermined size at a predetermined resolution based on that the first intra prediction mode is a directional mode. The operation of determining the intra prediction mode of the current block based on the first intra prediction mode may also include determining an intra prediction mode of the current block based on the third intra prediction mode and the fourth intra prediction mode. The encoding apparatus may generate a prediction block of the current block based on the intra prediction mode of the current block (S1960).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in this specification are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which this disclosure pertains should understand that the scope of the present disclosure is not to be limited by the above explicitly described embodiments but by the claims and equivalents thereof.

### REFERENCE NUMBER

122: intra predictor
510: entropy decoder
542: intra predictor

What is claimed is:

1. A video decoding method comprising:
deriving a most probable mode (MPM) list based on intra prediction modes of neighboring blocks adjacent to a current block;
generating prediction pixels by applying candidate modes in the MPM list or the intra prediction modes of the neighboring blocks to reference pixels of a first region adjacent to the current block;
calculating a sum of absolute transformed difference (SATD) between the prediction pixels and reconstructed pixels of the first region;
deriving a first intra prediction mode, based on the SATD;
deriving an intra prediction mode of the current block, based on the first intra prediction mode; and
generating a prediction block of the current block, based on the intra prediction mode of the current block.

2. The video decoding method of claim 1, wherein the first region is at least one of a top region, a left region, or a top left region of the current block.

3. The video decoding method of claim 1, wherein the first region is determined based on candidate modes in the MPM list.

4. The video decoding method of claim 1, wherein the first intra prediction mode is a candidate mode used to generate a prediction pixel having a minimum SATD.

5. The video decoding method of claim 1, wherein the first intra prediction mode is an intra prediction mode of a neighboring block used to generate a prediction pixel having a minimum SATD.

6. The video decoding method of claim 1, wherein the prediction pixels are generated based on the intra prediction modes of the neighboring blocks.

7. The video decoding method of claim 1, wherein generating the prediction pixels comprises:
generating an intra prediction mode list, based on the intra prediction modes of the neighboring blocks; and
generating the prediction pixels, based on the intra prediction mode list,
wherein the intra prediction mode list is generated using a frequency of occurrence of the intra prediction modes of the neighboring blocks.

8. The video decoding method of claim 1, wherein generating the prediction pixels comprises:
deriving a second intra prediction mode by applying a Sobel operation to the first region; and
generating the prediction pixels, based on the second intra prediction mode.

9. The video decoding method of claim 1, wherein deriving the intra prediction mode of the current block, based on the first intra prediction mode comprises:
deriving the first intra prediction mode as the intra prediction mode of the current block, based on that the first intra prediction mode is a non-directional mode.

10. The video decoding method of claim 1, wherein deriving the intra prediction mode of the current block, based on the first intra prediction mode comprises:
deriving a third intra prediction mode and a fourth intra prediction mode by increasing and decreasing the first intra prediction mode to a predetermined size at a predetermined resolution, based on that the first intra prediction mode is a directional mode; and
deriving the intra prediction mode of the current block, based on the third intra prediction mode and the fourth intra prediction mode.

11. A video encoding method comprising:
determining a most probable mode (MPM) list, based on intra prediction modes of neighboring blocks adjacent to a current block;
generating prediction pixels by applying candidate modes in the MPM list or the intra prediction modes of the neighboring blocks to reference pixels of a first region adjacent to the current block;
calculating a sum of absolute transformed difference (SATD) between the prediction pixels and reconstructed pixels of the first region;
determining a first intra prediction mode, based on the SATD;
determining an intra prediction mode of the current block, based on the first intra prediction mode; and
generating a prediction block of the current block, based on the intra prediction mode of the current block.

12. The video encoding method of claim 11, wherein the first region is at least one of a top region, a left region, or a top left region of the current block.

13. The video encoding method of claim 11, wherein the first region is determined based on candidate modes in the MPM list.

14. The video encoding method of claim 11, wherein the first intra prediction mode is a candidate mode used to generate a prediction pixel having a minimum SATD.

15. The video encoding method of claim 11, wherein the first intra prediction mode is an intra prediction mode of a neighboring block used to generate a prediction pixel having a minimum SATD.

16. The video encoding method of claim 11, wherein generating the prediction pixels comprises:
generating an intra prediction mode list, based on the intra prediction modes of the neighboring blocks; and
generating the prediction pixels, based on the intra prediction mode list,
wherein the intra prediction mode list is generated using a frequency of occurrence of the intra prediction modes of the neighboring blocks.

17. The video encoding method of claim 11, wherein generating the prediction pixels comprises:
deriving a second intra prediction mode by applying a Sobel operation to the first region; and
generating the prediction pixels, based on the second intra prediction mode.

18. The video encoding method of claim 11, wherein determining the intra prediction mode of the current block, based on the first intra prediction mode comprises:
determining the first intra prediction mode as the intra prediction mode of the current block, based on that the first intra prediction mode is a non-directional mode.

19. The video encoding method of claim 11, wherein determining the intra prediction mode of the current block, based on the first intra prediction mode comprises:
determining a third intra prediction mode and a fourth intra prediction mode by increasing and decreasing the first intra prediction mode to a predetermined size at a predetermined resolution, based on that the first intra prediction mode is a directional mode; and
determining the intra prediction mode of the current block, based on the third intra prediction mode and the fourth intra prediction mode.

20. A computer-readable recording medium storing a bitstream generated by a video encoding method, wherein the video encoding method comprises:
deriving a most probable mode (MPM) list, based on intra prediction modes of neighboring blocks adjacent to a current block;
generating prediction pixels by applying candidate modes in the MPM list or the intra prediction modes of the neighboring blocks to reference pixels of a first region adjacent to the current block;
calculating a sum of absolute transformed difference (SATD) between the prediction pixels and reconstructed pixels of the first region;
deriving a first intra prediction mode, based on the SATD;
deriving an intra prediction mode of the current block, based on the first intra prediction mode; and
generating a prediction block of the current block, based on the intra prediction mode of the current block.
